(19) United States
(12) Patent Application Publication
(10) Pub. No.: US 2026/0349798 A1
(43) Pub. Date: Nov. 5, 2026

(54) PRIVACY PRESERVING EDGE-CLOUD COLLABORATION FOR EMBODIED AI AGENTS

(71) Applicant: Cisco Technology, Inc., San Jose, CA (US)

(72) Inventors: Gaowen Liu, Naperville, IL (US); Ramana Rao V.R. Kompella, Foster City, CA (US); Charles Fleming, Oxford, MS (US)

(73) Assignee: Cisco Technology, Inc., San Jose, CA (US)

(21) Appl. No.: 19/194,410

(22) Filed: Apr. 30, 2025

(51) Int. Cl. G06F 9/50

(52) U.S. Cl. CPC G06F 9/5016; G06F 9/5066

(57) ABSTRACT

In one implementation, a device makes a classification of sensor data captured by an embodied agent. The device selects, based on the classification of the sensor data, between storing the sensor data in a local memory in a local network of the embodied agent or in a cloud memory in a cloud location. The device makes a classification of a subtask of a task to be performed by the embodied agent. The device selects, based on the classification of the subtask, whether the subtask is to be performed in the local network using the local memory or in the cloud location using the cloud memory.

### TECHNICAL FIELD

The present disclosure relates generally to artificial intelligence and, more specifically, to privacy preserving edge-cloud collaboration for embodied artificial intelligence (AI) agents.

### BACKGROUND

The recent breakthroughs in large language models (LLMs) and other generative artificial intelligence (AI) represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more generative AI models. Embodied agents take this one step further by also being able to interact with their physical environments.

Embodied agents for household and industrial applications provide convenience but also introduce significant privacy concerns. Such agents often utilize cameras, microphones, and/or other sensors to gather data on users, their behaviors, and their environment. When this data is transmitted to cloud servers, it poses the risks of unauthorized access and privacy breaches.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a generative model;

FIG. 4 illustrates an example architecture for an artificial intelligence (AI) agent;

FIG. 5 illustrates an example of embodied AI agents deployed in a warehouse;

FIG. 6 illustrates an example architecture for privacy preserving edge-cloud collaboration for embodied AI agents; and

FIG. 7 illustrates an example simplified procedure for privacy preserving edge-cloud collaboration for embodied AI agents, in accordance with one or more implementations described herein.

### DESCRIPTION OF EXAMPLE IMPLEMENTATIONS

### Overview

According to one or more implementations of the disclosure, a device makes a classification of sensor data captured by an embodied agent. The device selects, based on the classification of the sensor data, between storing the sensor data in a local memory in a local network of the embodied agent or in a cloud memory in a cloud location. The device makes a classification of a subtask of a task to be performed by the embodied agent. The device selects, based on the classification of the subtask, whether the subtask is to be performed in the local network using the local memory or in the cloud location using the cloud memory.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or PLC networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc. ;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

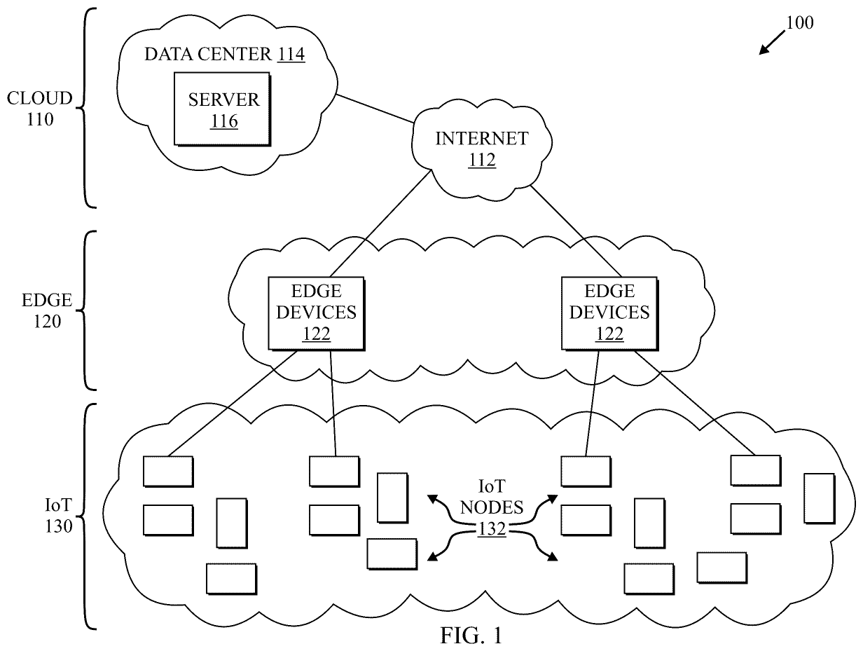

FIG. 1 is a schematic block diagram of an example simplified computer network 100 illustratively comprising nodes/devices at various levels of the network, interconnected by various methods of communication. For instance, the links may be wired links or shared media (e.g., wireless links, PLC links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, PLC protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc..), PLC protocols, or other shared-media protocols where appropriate. In this context, a protocol consists of a set of rules defining how the nodes interact with each other.

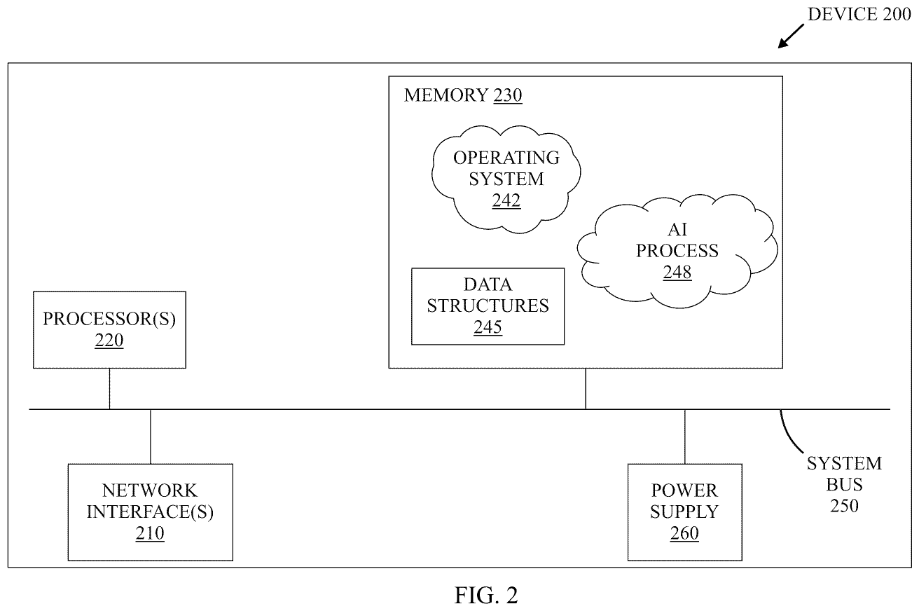

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, a Global Positioning System (GPS) receiver, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI process 248 can use include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also use one or more generative AI/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs) and other foundation models, diffusion models, transformer models, and the like.

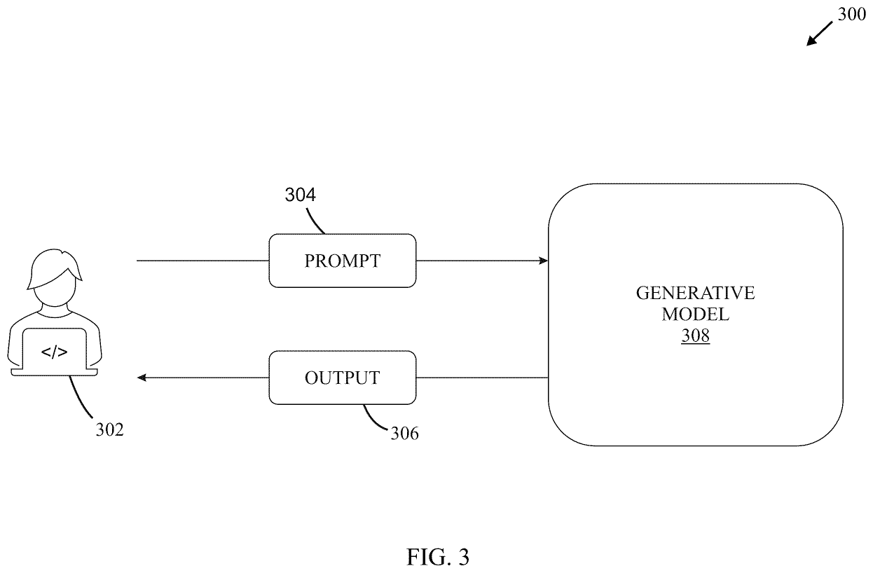

FIG. 3 illustrates an example 300 for interfacing with a generative model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated/synthesized image, a text response, a classification, a prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

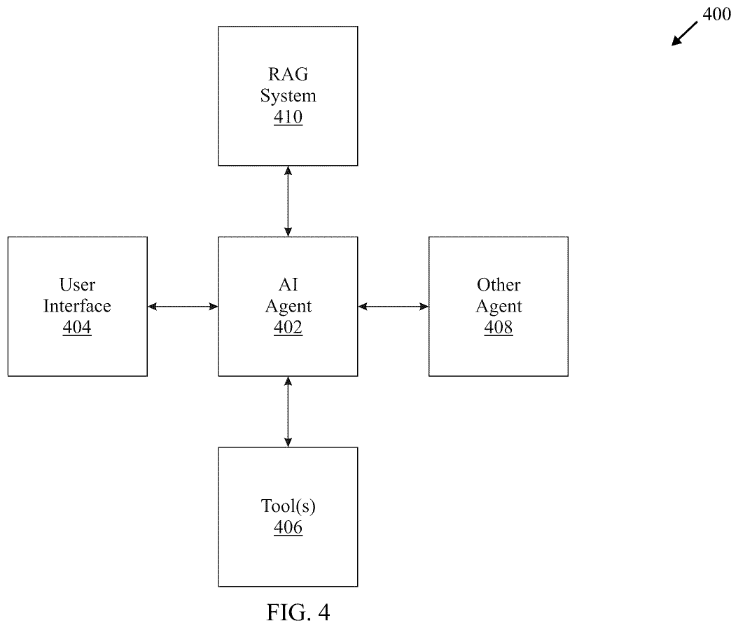

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, embodied agents take the capabilities of AI agents one step further by also being able to interact with their physical environments. Indeed, embodied agents typically take the form of a device or system that includes:
One or more sensors to capture sensor data from the physical environment of the embodied agent. Such sensors may include, but are not limited to, a camera, radar, a Light Detection and Ranging (LiDAR) sensor, an infrared (IR) sensor, a pressure sensor, an accelerometer, a proximity sensor, a vibration sensor, a temperature sensor, an ultrasonic sensor, a microphone, or a magnetic sensor, to name a few.
One or more actuators to interact with the physical environment. Such actuators may include, but are not limited to, actuators to control the movement of the embodied agent, actuators to carry an object located in the environment, actuators to interface or otherwise interact with an object located in the environment, or the like. In various cases, such actuators may be powered by hydraulics, electric motors, pneumatics, or any other suitable mechanism.

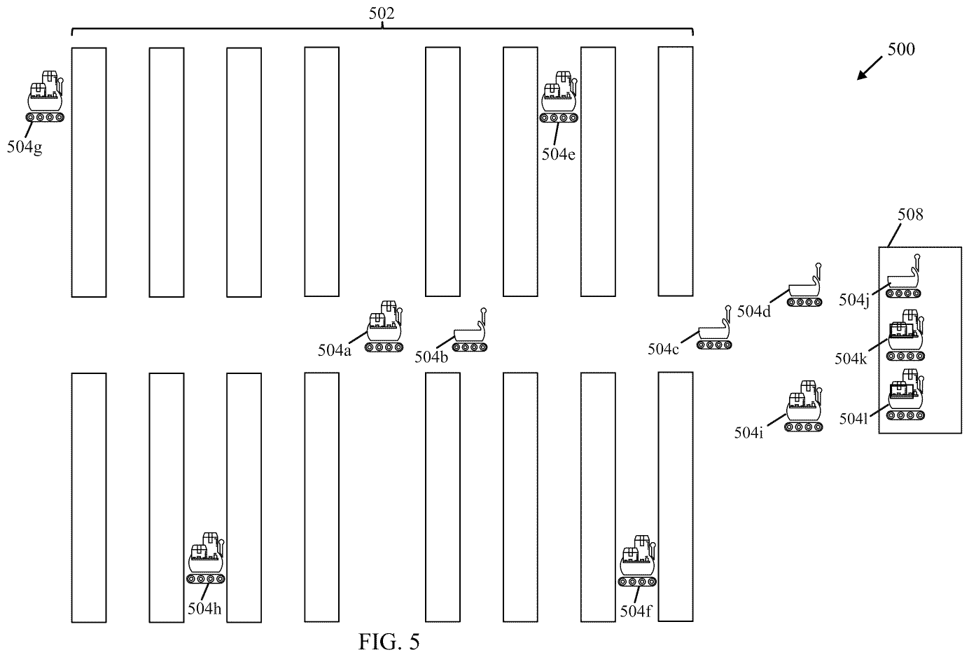

By way of example, FIG. 5 illustrates an example of embodied AI agents deployed in a warehouse 500. As shown, assume that a plurality of inventory racks 502 are distributed throughout warehouse 500 for purposes of storing items. As would be appreciated, inventory racks 502 are optional and other forms of storage systems may be deployed throughout warehouse 500, in other cases. For instance, warehouse 500 may also include containers, holding pens, or the like, in which various items may be stored.

To aid in the storage and/or retrieval of the items in the warehouse 500, any number of embodied agents 504 may be deployed to warehouse 500, such as embodied agents 504a-504l shown. In general, embodied agents 504 may take the form of robots controlled by a respective AI agent. In addition, each embodied agent 504 may include a propulsion system that propels the robot (e.g., an engine coupled to wheels, treads, etc.), one or more sensor systems (e.g., infrared, sonar, video, etc.), a communication system (e.g., wireless, hardwired port, etc.), and a computer control system coupled to the other systems that provides supervisory control over the other systems.

In some embodiments, embodied agents 504 may also include mechanisms to automatically load and/or unload items, such as forklifts, mechanical claws, or the like. In other embodiments, embodied agents 504 may require the assistance of human workers to load and unload items to and from them, such as at a pack-out area 508.

In some instances, embodied agents 504 may be partially or fully autonomous, allowing them to complete their tasks, independently. For instance, a particular embodied agent 504 may be sent a task list that indicates the set of items that the robot is to retrieve from within warehouse 500, navigation information if so needed, or any other information that may be required for the performance of its retrieval functions.

Of course, there are many other use cases for embodied agents beyond that of warehouse inventory storage and retrieval. For instance, embodied agents may be deployed in residential, industrial, or educational environment to achieve various tasks, as well. For instance, an embodied agent may be deployed in a residence for purposes of performing household tasks (e.g., cleaning, cooking, etc.). In an industrial setting, however, an embodied agent may be tasked with conveying objects between locations, assembling or disassembling objects, or the like. In an educational environment, an embodied agent may be tasked with teaching lessons to students, demonstrating lessons or techniques, or the like. As would be appreciated, the teachings herein are not limited to any particular use case for embodied agents and can apply to any number of different use cases.

While embodied agents present significant advantages with respect to efficiency and convenience, their presence in certain environments can also raise privacy concerns. Indeed, such agents often utilize cameras, microphones, and/or other sensors to gather data on users, their behaviors, and their environment. When this data is transmitted to cloud servers for purposes of the agent using an AI model to complete its given task, doing so may also pose the risks of unauthorized access and privacy breaches.

### Privacy Preserving Edge-Cloud Collaboration for Embodied AI Agents

The techniques herein help to preserve privacy in systems with embodied AI agents by bifurcating the processing of the captured sensor data in local and cloud-hosted locations. More specifically, the techniques herein apply a privacy policy to sensor data captured by an embodied agent by classifying the sensor data, thereby preventing sensor data deemed private from leaving the local network of the embodied agent. For instance, the embodied agent may store the sensor data in an on-board memory or at a particular device in its local network, such as at an edge device (e.g., any of edge devices 122 in FIG. 1). Non-private sensor data, meanwhile, may be sent to the cloud normally. Further aspects of the techniques herein relate to a second classification mechanism that classifies the various subtasks that the agent is to perform, to complete its task. A subtask that is considered private (e.g., relies on private sensor data and/or entails an interaction with the environment that is considered private/sensitive), may be processed within the local network (e.g., at the edge) using the locally-stored sensor data. Conversely, non-private subtasks may be processed in the cloud using the non-private sensor data.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device makes a classification of sensor data captured by an embodied agent. The device selects, based on the classification of the sensor data, between storing the sensor data in a local memory in a local network of the embodied agent or in a cloud memory in a cloud location. The device makes a classification of a subtask of a task to be performed by the embodied agent. The device selects, based on the classification of the subtask, whether the subtask is to be performed in the local network using the local memory or in the cloud location using the cloud memory.

Operationally, the framework introduced herein is premised on certain (sub)tasks and data being restricted to local (e.g., edge-based) processing, while other (sub)tasks and data can be performed in the cloud. Doing so keeps those tasks considered sensitive/private on-prem, thereby preserving the privacy of the tasks and their associated data.

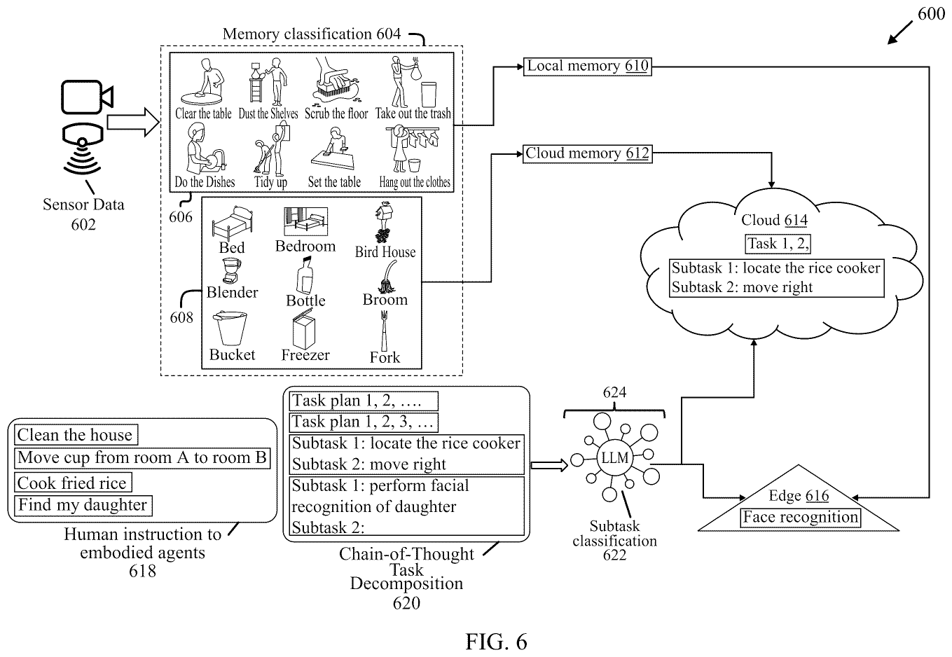

FIG. 6 illustrates an example architecture 600 for privacy preserving edge-cloud collaboration for embodied AI agents, according to various implementations. In this framework, the techniques herein incorporate chain-of-thought reasoning into the policy training of embodied agents. This approach generally involves any or all of the following:
Identifying and locating task-relevant objects.
Developing a step-by-step plan to achieve the task.
Decomposing the task into smaller sub-tasks.
Allocating sub-tasks between local and cloud-based systems.
Converting sub-tasks and observations into actionable movements.

By doing so, only certain (sub)tasks are eligible for processing in the cloud, thereby preserving the privacy of those restricted from off-site processing.

More specifically, as shown, assume that there is an embodied agent (e.g., an AI-powered robot) that captures sensor data 602 from its physical environment. As noted above, sensor data 602 may include data generated by one or more sensors of the embodied agent (e.g., a camera, a microphone, etc.) that captures information regarding the physical characteristics of the environment. In some implementations, sensor data 602 may also include state or status information regarding the past, current, or planned actions of the embodied agent and/or their outcomes.

In turn, system 600 may perform a memory classification 604 of sensor data 602. Such a classification may entail, for instance, identification of certain actions, conditions, objects, or the like that are present in the physical environment of the embodied agent. To do so, architecture 600 may leverage one or more AI-based classifiers, which may be multimodal (e.g., able to classify both audio and video inputs) or unimodal (e.g., video only), in some implementations. Such a model may reside locally on the embodied agent itself, on an edge device in the local network of the embodied agent, or some other device on the local network, so as to ensure that sensor data 602 is not simply transmitted externally, thus posing a potential privacy risk.

Associated with the results of memory classification 604 may be information indicating whether the assigned class(es) are considered to be private/sensitive. In some instances, these associations may be pre-configured or set by default. In other instances, a user may be able to specify their privacy preferences to architecture 600 for purposes of memory classification 604 via a user interface.

As shown, assume that memory classification 604 has resulted in two groups of classifications: a private group 606 comprising classifications that architecture 600 deems private and a non-private group 608 comprising classifications that architecture 600 does not consider private.

According to various implementations, architecture 600 may control where sensor data 602 (and, potentially, its classifications) are stored. More specifically, architecture 600 may store sensor data 602 associated with private group 606 in local memory 610 within the local network, based on it being deemed private. For instance, local memory 610 may be local to the embodied agent, on an edge device in the local network, or another suitable storage location in the local network. Conversely, architecture 600 may send sensor data 602 associated with non-private group 608 to cloud memory 612 in the cloud for storage and processing.

Consider now the case in which a human user or, alternatively, a computerized agent, issues an instruction 618 for the embodied agent to perform a task. For instance, a human user may issue any of the following instructions:
“Clean the house”
“Move Cup From Room A to Room B”
“Cook fried rice”
“Find my daughter”

In various implementations, architecture 600 may leverage an LLM 624 or other suitable AI model to perform chain-of-thought task decomposition 620. Such a model may typically be executed in the cloud. However, further implementations provide for the model to be executed within the local network (e.g., at the edge, on the embodied agent, etc.). In such cases, the model may also be specialized to the specific functions of architecture 600, so as to reduce its resource requirements.

The result of chain-of-thought task decomposition 620 is a set of subtasks that need to be performed, for the embodied agent to complete the task indicated by instruction 618. For instance, consider the case in which the task is “cook fried rice.” In such a case, the task decomposition may include subtasks “locate the rice cooker,” and “move right,” etc. Similarly, if the task is “find my daughter,” the subtasks may include “perform facial recognition of daughter,” etc.

In various implementations, LLM 624 may perform subtask classification 622 on the subtasks identified by chain-of-thought task decomposition 620. A goal of subtask classification 622 may be to determine whether a given subtask is considered private or non-private. For instance, subtask classification 622 may identify the objects, actions, etc. associated with a given subtask. Such classes may be associated with the same private/non-private flags used for memory classification 604. These associations may also be updated as desired via a user interface, in some instances.

Through subtask classification 622, architecture 600 may process private subtasks within the local network of the embodied agent and non-private subtasks in the cloud. As shown, for instance, say that the subtasks of locating the rice cooker and moving right are non-private subtasks. In such a case, architecture 600 may process these subtasks in cloud platform 614 using the non-private data stored in cloud memory 612. Conversely, assume that performing facial recognition is considered to be private. In such a case, architecture 600 may process this subtask at edge device 616 using the private data stored in local memory 610.

The result of this bifurcated processing is that private data from the embodied agent is retained within its local network without transmitting it to the cloud for processing. Non-private data, though, can still be processed in the cloud, which may have greater computing resources.

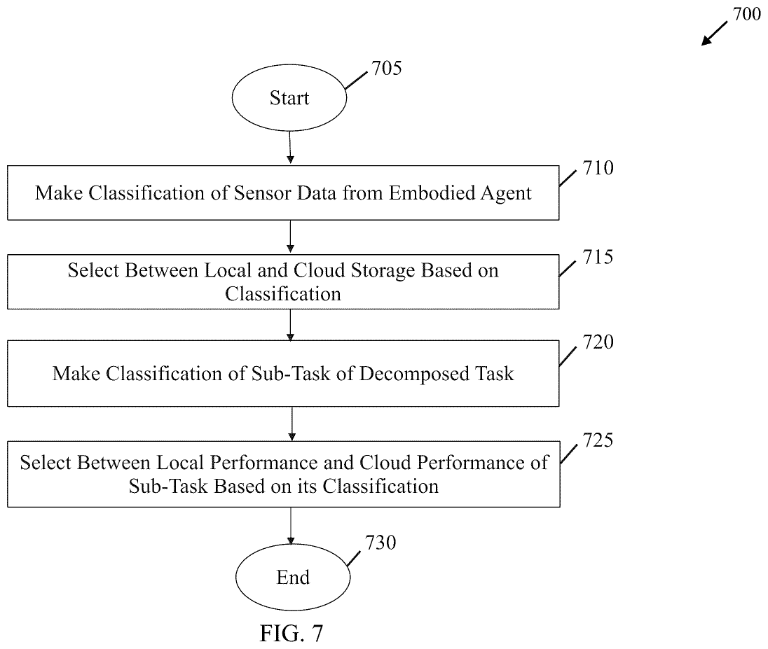

FIG. 7 illustrates an example simplified procedure for privacy preserving edge-cloud collaboration for embodied AI agents, in accordance with one or more implementations described herein. For example, a non-generic, specifically configured device (e.g., device 200), may perform procedure 700 (e.g., a method) by executing stored instructions (e.g., AI process 248). The procedure 700 may start at step 705, and continues to step 710, where, as described in greater detail above, the device (e.g., a controller, server, etc.) may make a classification of sensor data captured by an embodied agent. In some implementations, the embodied agent comprises the device. In various implementations, the embodied agent comprises at least one sensor to capture the sensor data from a physical environment and at least one actuator to interact with the physical environment. In some cases, the task is specified by a user.

At step 715, as detailed above, the device may select, based on the classification of the sensor data, between storing the sensor data in a local memory in a local network of the embodied agent or in a cloud memory in a cloud location. In some instances, the device selects the local memory to store the sensor data when the classification of the sensor data indicates a presence of an object or action deemed private. In some implementations, the device may also use an artificial intelligence model to decompose the task into a plurality of subtasks that include the subtask. In one implementation, the artificial intelligence model is a large language model. In a further implementation, the artificial intelligence model uses chain-of-thought reasoning to decompose the task.

At step 720, the device may make a classification of a subtask of a task to be performed by the embodied agent, as described in greater detail above. In various implementations, the subtask is performed by an edge computing node in the local network. In one implementation, the artificial intelligence model classifies the subtask as a private task to be performed in the local network using the local memory.

At step 725, as detailed above, the device may select, based on the classification of the subtask, whether the subtask is to be performed in the local network using the local memory or in the cloud location using the cloud memory.

Procedure 700 may then end at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for privacy preserving edge-cloud collaboration for embodied AI agents, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
making, by a device, a classification of sensor data captured by an embodied agent;
selecting, by the device and based on the classification of the sensor data, between storing the sensor data in a local memory in a local network of the embodied agent or in a cloud memory in a cloud location;
making, by the device, a classification of a subtask of a task to be performed by the embodied agent; and
selecting, by the device and based on the classification of the subtask, whether the subtask is to be performed in the local network using the local memory or in the cloud location using the cloud memory.

2. The method as in claim 1, wherein the embodied agent comprises the device.

3. The method as in claim 1, wherein the subtask is performed by an edge computing node in the local network.

4. The method as in claim 1, wherein the device selects the local memory to store the sensor data when the classification of the sensor data indicates a presence of an object or action deemed private.

5. The method as in claim 1, further comprising:
using an artificial intelligence model to decompose the task into a plurality of subtasks that include the subtask.

6. The method as in claim 5, wherein the artificial intelligence model is a large language model.

7. The method as in claim 5, wherein the artificial intelligence model uses chain-of-thought reasoning to decompose the task.

8. The method as in claim 5, wherein the artificial intelligence model classifies the subtask as a private task to be performed in the local network using the local memory.

9. The method as in claim 1, wherein the embodied agent comprises at least one sensor to capture the sensor data from a physical environment and at least one actuator to interact with the physical environment.

10. The method as in claim 1, wherein the task is specified by a user.

11. An apparatus, comprising:
one or more network interfaces;
a processor coupled to the one or more network interfaces and configured to execute one or more processes; and
a memory configured to store a process that is executable by the processor, the process when executed configured to:
make a classification of sensor data captured by an embodied agent;
select, based on the classification of the sensor data, between storing the sensor data in a local memory in a local network of the embodied agent or in a cloud memory in a cloud location;
make a classification of a subtask of a task to be performed by the embodied agent; and
select, based on the classification of the subtask, whether the subtask is to be performed in the local network using the local memory or in the cloud location using the cloud memory.

12. The apparatus as in claim 11, wherein the embodied agent comprises the apparatus.

13. The apparatus as in claim 11, wherein the subtask is performed by an edge computing node in the local network.

14. The apparatus as in claim 11, wherein the apparatus selects the local memory to store the sensor data when the classification of the sensor data indicates a presence of an object or action deemed private.

15. The apparatus as in claim 11, wherein the process when executed is further configured to:
use an artificial intelligence model to decompose the task into a plurality of subtasks that include the subtask.

16. The apparatus as in claim 15, wherein the artificial intelligence model is a large language model.

17. The apparatus as in claim 15, wherein the artificial intelligence model uses chain-of-thought reasoning to decompose the task.

18. The apparatus as in claim 15, wherein the artificial intelligence model classifies the subtask as a private task to be performed in the local network using the local memory.

19. The apparatus as in claim 11, wherein the embodied agent comprises at least one sensor to capture the sensor data from a physical environment and at least one actuator to interact with the physical environment.

20. A tangible, non-transitory, computer-readable medium storing program instructions that cause a device to execute a process comprising:
making, by the device, a classification of sensor data captured by an embodied agent;
selecting, by the device and based on the classification of the sensor data, between storing the sensor data in a local memory in a local network of the embodied agent or in a cloud memory in a cloud location;
making, by the device, a classification of a subtask of a task to be performed by the embodied agent; and
selecting, by the device and based on the classification of the subtask, whether the subtask is to be performed in the local network using the local memory or in the cloud location using the cloud memory.
